(19) United States
(12) Patent Application Publication
(10) Pub. No.: US 2009/0174759 A1
(43) Pub. Date: Jul. 9, 2009

(54) AUDIO VIDEO COMMUNICATIONS DEVICE

(75) Inventors: Jason Yeh, Bethesda, MD (US); Larwan Berke, Rockville, MD (US)

Correspondence Address: LARSON AND LARSON, 11199 69TH STREET NORTH, LARGO, FL, 33773, US

(73) Assignee: VIABLE COMMUNICATIONS, INC., Rockville, MD (US)

(21) Appl. No.: 12/177,201

(22) Filed: Jul. 22, 2008

Related U.S. Application Data
(60) Provisional application No. 61/018,998, filed on Jan. 4, 2008.

(51) Int. Cl. H04N 7/14

(52) U.S. Cl. 348/14.01; 348/E07.078

(57) ABSTRACT

An all-in-one embedded audio video communications device used for connecting through a packet-type network, such as the Internet, or a Public Switched Telephone Network (PSTN). The device employs a plurality of features that accommodates the needs of the hard of hearing and speech and/or hearing impaired communities. Some of the features include a touchscreen monitor, an internal camera and a flashing light alert system. The device employs a novel GUI which makes navigating through the menus of the device quick and easy. Connectivity to a packet-type network can be realized through an Ethernet connection, an SDIO slot, or other known wireless means. Other connection ports include a USB 2.0 port, an RJ-11 port and A/V In and Out jacks. The device can establish a user profile which facilitates a connection with a Video Relay Service provider or a point-to-point end user who uses sign language as their native language.

### PRIOR APPLICATIONS

This non-provisional patent application claims priority to U.S. provisional patent application No. 61/018,998, filed on Jan. 4, 2008.

### BACKGROUND OF THE INVENTION

1. Field of Invention

The present invention relates to an audio video communications device. More particularly, it relates to an audio video communications device that operates primarily as an improved videophone device operable along a public switched telephone network or over a packet-type network such as the Internet, wherein enhanced features are provided for assisting persons that are hard of hearing or speech and/or hearing impaired.

2. Description of the Prior Art

Videophones are known in the prior art. Early advancements in videophone devices included devices that were attached to a regular telephone (or made as an integral part of a regular telephone) and were used over a PSTN or “Public Switched Telephone Network.” The users of such devices were inhibited by the fact the person being called on the other end had to have the same or similar videophone device to receive the call to the extent that visual contact was desired between the two parties. Even then, the quality of the video was extremely poor, wherein the number of video frames per seconds that was transmitted and received was typically less than 10, which gave the video connection the appearance of “jumping.” This was considered normal and tolerated by capable hearing users as they were merely interested in seeing the face of the other user, which of course was then supplemented by a clear audio signal over the PSTN. However, as can be appreciated, such a device was essentially useless to the speech or hearing impaired when using sign language, such as ASL (or “American Sign Language”), as just one example, to communicate. Any person using sign language (considered to be the first and native language of the deaf) requires a full streaming video signal, such as 30 fps (frames per second), to ensure that all hand signals used during the sign language communication can be understood. The effect of “jumping” frames renders sign language completely useless with a video connection between two parties since “true-to-life” video quality is required to ensure proper communication between the two persons using sign language. It is analogous to a hearing/spoken word telephone call, wherein every couple of spoken words are dropped or not transmitted and therefore not heard by the person on the receiving end. This causes the person on the receiving end to not understand what is being said.

However, with the advent of the Internet, a sharp rise in the use of web cams (typically small video cameras, whose images can be accessed using the World Wide Web, through the use of an instant messaging service or a PC video conferencing application) has given those who are speech and/or hearing impaired the ability to make improved video connections between two parties or through the use of a Video Relay Service (also known as “VRS,” which will be discussed more fully hereinafter). Video connections using web cams, based upon the amount of bandwidth being used by both parties and other considerations such as speed of the computing hardware, have provided a means for sign language users to communicate in absence of being physically present in front of one another. This is due to the fact that if the two parties are using the right hardware and Internet connection, 30 fps of streaming video (true-to-life quality) can be realized.

With that said however, many problems continue to plague videophone devices that use web cams for their video transmitting device, or just web cams themselves when making a live video connection between two parties. These problems have frustrated the speech and hearing impaired community. Many of these problems are based upon hardware and computer network protocol incompatibility, among other things. These problems are so prevalent that improvements in videophone devices and an appreciation for the features needed for the speech and hearing impaired community warrant the development and introduction of an all-in-one embedded videophone device for the speech and hearing impaired.

Efforts have been made by the US Government to bring an appreciation and awareness to those who are hearing capable of the plight of the speech and hearing impaired. This effort actually started many years ago when telecommunications access was mandated by Title IV of the Americans with Disabilities Act (ADA) of 1990 with the purpose of enabling speech and hard of hearing persons to achieve functional equivalence to capable hearing persons in a telephone call. Early solutions are well known and were text-based, which required typing out calls through an intermediary known as a Relay Operator or through the use of a TDD (telecommunications device for the deaf) system. Both of these systems are text-based solutions, are slow and require the two parties talking to be at least capable if not proficient at spelling and typing in the same written language.

However, with the emergence of IP technology, video-based solutions have begun to appear. One of the most important solutions is known as Video Relay Services (VRS). To use such a service, a speech or hearing impaired person, for whom sign language is their first and native language, can use a VRS provider to connect to a video interpreter (VI), of the VRS provider, allowing the speech or hearing impaired person to fully achieve the functional equivalence of a hearing capable, spoken word telephone call. When connected to a VRS provider, the person making the call will see a VI who in turn sees that person by means of a two-way video connection. The VI is given the telephone number of a friend, relative, business associate or other person to dial by the person initiating the call (in this example, a deaf person). The VI dials the number to make contact with another person (in this example, a hearing capable person). When the hearing capable person answers the call, the parties proceed like any normal phone conversation whereby the VI interprets the sign language of the deaf person for the capable hearing person using the native voice language of the conversation, and in addition interprets the native voice language of the person speaking by signing to the speech or hearing impaired person. The only person involved in the VRS call that needs to be able to speak and sign is the VI. Although it is more normal for the speech or hearing impaired person to initiate the VRS call, there is no requirement that this be so. So long as one of the persons to the call is speech or hearing impaired and he or she wants to communicate with a hearing capable person, the VRS system can be used as mandated by the ADA. All Video Relay Services in the US are overseen by the Federal Communications Commission (FCC) and funded by the National Exchange Carrier Association (NECA).

When using a VRS provider, it is obvious that the speech or hearing impaired person who wishes to make a VRS call must have some form of videophone or web cam device. However, as stated above, many of the issues that plague these technologies have not been solved by the mere creation of the VRS system. In fact, the existence of VRS has created a greater demand for more and better technology as a larger number of speech and hearing impaired persons start to realize that they too can have a hearing capable, spoken word functionally equivalent telephone conversation with their friends, family and/or business associates.

Therefore, there is now a greater demand for an improved videophone device that can not only be used, and therefore be compatible, with the VRS system, but which is also capable of being used for point-to-point calls between two people whom both are competent in a particular sign language such as ASL and wish to talk directly by a video connection and without the aid of the VRS system and a VI. There is no device in the prior art that is an all-in-one embedded videophone having all of the necessary features needed for the speech and hearing impaired, which is not only compatible with the VRS system, like that in the US, but is also compatible with point-to-point video connections over packet-type networks (i.e., the Internet) as well as a PSTN. Such a device is clearly needed.

### SUMMARY OF THE INVENTION

We have invented an all-in-one embedded audio video communications device that in a first aspect is an improved videophone device having a plurality of features that are specifically employed to benefit the hard of hearing and speech and hearing impaired community. The term “videophone” as used herein means a telephone capable of both audio and video duplex transmission, and which primarily serves individuals and not groups (such as that employed in videoconferencing). However, alternate embodiments can be used in videoconferencing situations. As a hardware videophone device, the present invention, through the use of a novel and proprietary GUI (Graphic User Interface) it is capable of calling any SIP (Session Initiation Protocol) or H.323 (an umbrella recommendation from the ITU Telecommunication Standardization Sector that defines the protocols to provide audio-visual communication sessions on any packet network) compliant application or device. With an adjustable but integrated camera and an LCD (liquid crystal display) touch-screen sensitive monitor employed therewith, the all-in-one audio video communications device of the present invention allows users to communicate either directly with other end point users or through a NECA-funded VRS system provider with true-to-life quality audio and video. The audio video communications device of the present invention is small in size, lightweight and portable and therefore can be easily transported from one location (i.e., an office or home) to another location such as to an Internet Cafe, an airport or any other location having a wireless hot spot, or WiFi capabilities. The device runs on AC power with the use of a DC power converter or by batteries. Network connectivity is through either a PSTN or a packet-type network like the Internet.

Further, in regards to the first aspect of the present invention as an improved videophone device, the present invention is a standalone device, since it employs a touchscreen user interface. This allows intuitive user interface and quick navigation through the menus of the GUI application, embedded therein. This feature is a significant improvement over the prior art, which employ wireless remotes or built in buttons that resemble a remote for navigating through the functions of the videophone device. Wireless remotes suffer from being frequently misplaced or rendered inoperable when the batteries die, and on-board buttons require lengthy navigation procedures using limited buttons, and which also makes text input a difficult and time consuming task. Our improved device does not suffer from these prior art deficiencies because these features are eliminated. In particular, our touchscreen allows the user to operate the device of the present invention without any dependency on additional external devices such as a remote control. This benefits the user by allowing him or her to immediately press any button they want to select on the touchscreen instead of having to navigate through numerous button combinations to arrive at their preferred button activation. The touchscreen therefore provides for minimal setup time. The user has the option of using their fingertips or a stylus pen for increased precision and accuracy, depending on specific individual preferences. The touchscreen also reduces the time it takes a user to learn the proper operation of the device, and allows a true “plug and play” experience with minimal concentration and effort.

An important part of the touchscreen user interface is the ability to perform one-touch dialing. This can be used to initiate an immediate connection with a NECA-funded VRS provider or an SIP and H.323 compliant private sector VRS provider of the user's choice or a point-to-point connection with another user using SIP and H.323 (or other similar protocol) compliant software applications and hardware devices. The one-touch dialing feature can be further augmented by connecting to a preferred Video Interpreter (VI) within a preferred VRS provider based upon profile settings established by the user in the novel device of the present invention. This feature proves extremely useful when someone desires to connect to a VI who speaks a specific spoken language like English, Spanish, French, German or Russian, just to name a very few of the what is estimated to be over 6800 spoken languages in the world today.

Profile settings include, but are not limited to, gender, language, location, and interpretation certification level. Further, the one-touch dialing feature permits automatic call distribution, which permits the user the option of waiting for the most relevant interpreter, or being connected with the first available interpreter even if the interpreter may or may not match all of their profile settings. One-touch dialing also permits the user the option of passing the phone number they wish to dial to the VRS interpreter prior to being connected thereto to minimize setup time for the call, thereby making the call more efficient and for ensuring a connection to the best available interpreter.

Still further to the first aspect, the videophone device of the present invention employs an alert system, which for the hard of hearing or hearing impaired is a set of LED lights. The lights are located on a top potion of the device and can be customizable to flash a variety of colors (red, blue, green, etc.) in various patterns, such as a flash, slow tone, or in creative random patterns. The user may set the lights to flash for a limited period of time, or continuously until the call is answered or the person calling “hangs up.” The user may also set the lights to flash each time a message is left in an “in-box” of the device as well, similar to how audio devices “beep” or emit a tone when such an event occurs (i.e., such as voicemail message on a cellular phone, but in this case video mail). The user can even program different colors to indicate a call coming from a specific person, similar to the ringtones used in cellular telephones. The lights provide a visual alert to anyone within eyesight of the device, thereby minimizing the event of a missed call or other potential event. Even further, a RJ-11 port is provided on the device, which is the standard for visual and physical communications systems in homes, offices, and other public locations. With appropriate RJ-11 compliant devices, a user can have their home lights flash, their bed vibrate, or have a belt-attached pager device or cell phone vibrate (by wireless transmission), for example, when an incoming call occurs on device 10. This feature allows the user the benefit of not being in the same room as their videophone device, but still being alerted to the presence of an incoming call or message.

In a second aspect, the videophone device of the present invention can be employed as a text messaging device in coincidence with the audio video communication device features or as a standalone text messaging system. Input of text for transmission can be realized through the use of the touchscreen user interface or through connection of a standard computer keyboard in a USB port of the device or by infrared communication therein. By utilizing text input, users may use the device for instant messaging, text messaging, IP Relay or to make TDD calls. Text can also be used to supplement a video call, such as to pass numerical information, to clarify complicated or new vocabulary, jargon or slang or vice versa with text as the primary mode of communication with video supplementing the conversation.

In a third aspect, the videophone of the present invention can operate as standard telephone or a traditional videophone that fulfills the needs and requirements of the hearing capable, spoken word community. As such, a microphone and speakers are provided for speaking with and listening to a person on the other end of the telephone call. Further, audio alerts, used for similar reasons as stated above for the hard of hearing or hearing impaired, are also provided for hearing capable. The audio alerts emit tones, rings and other sounds that and can be programmed for a plurality of purposes (i.e., notice of an incoming call or receipt of a voicemail message) through the user interface of the GUI.

In a fourth aspect, the videophone of the present invention may be used as a fully operable communication device for remote customer support and other similar services. Using a variety of subscription and pay-as-you-go models, consumers can utilize the device of the present invention to receive on-site support and services for a multitude of applications and services. These services may include Video Remote Interpreting, mechanical support in a service garage or the tutoring of students who need help with their homework, to name just a few examples. The device of the present invention allows a user to have visual and audio access to anyone who may not be in the same room, building, or even country that they are located, so long as the user on the other end is using SIP and H.323 compliant applications and hardware and there is access to either a packet-type or public switched telephone network. As just one of many examples, a business negotiation can be held by two groups or two individuals from opposite sides of the World (i.e., New York and Tokyo) by one party to the negotiation forwarding by express courier a pre-programmed device of the present invention to the other party.

Then, when the negotiation is ready to commence, a very simple point-to point connection is made between the two devices and real-time video and audio is achieved.

In a fifth aspect, the audio video communications device of the present invention can be used as a digital content monitor. As such, through the use of a plurality of different connectors, the device of the present invention can reproduce digital photos or pre-recorded video, or can be used as a television monitor or reproduce audio content. Devices such as MP3 players, DVD players, game consoles, digital cameras and camcorders, PDAs and PCs, to name just some examples, can all be connected to the novel audio video communication device of the present invention.

Network connectivity, depending on the desired use of the device of the present invention, can be achieved through an RJ-11 port, a high speed Ethernet port, through a SDIO (Secure Digital Input Output) WiFi slot or through an EVDO (Evolution-Data Optimized) wireless connection, or any combination thereof for providing redundancy to device 10.

### BRIEF DESCRIPTION OF THE DRAWINGS

The detailed description of the invention, contained herein below, may be better understood when accompanied by a brief description of the drawings, wherein:

FIG. 1 is a front plan view of the novel audio video communication device of the present invention;

FIG. 2 is a bottom plan view thereof;

FIG. 3 is a left side view thereof;

FIG. 4 is a right side view thereof;

FIG. 5 is a back side perspective view of the novel audio video communication device of the present invention showing a kickstand in its “non-engaged” position;

FIG. 6 is a left side perspective view thereof showing the kickstand in its “engaged for use” position;

FIG. 7 is a left side perspective view thereof showing the kickstand in a “pivoted-out” position illustrating how rubber stoppers are removed from the kickstand for subsequent attachment of a separate mounting device to the device;

FIG. 8 is a back side perspective view illustrating how a separate mounting device (in this figure a wall-arm mounting device) is attached to the kickstand for supporting the audio video communication device of the present invention to a wall or other like surface;

FIG. 9 is a front side perspective view of the audio video communication device of the present invention mounted to a wall or other like surface utilizing the mounting device as shown in FIG. 8;

FIG. 10 is a diagram illustrating how the audio video communication device of the present invention can be connected to any standard television or like monitor device; and

FIG. 11 is a diagram illustrating how the videophone device of the present invention can be connected to a multitude of different content providing devices, such as, by way of mere example, a DVD player, a game console or a camcorder.

### DETAILED DESCRIPTION OF THE PREFERRED EMBODIMENT

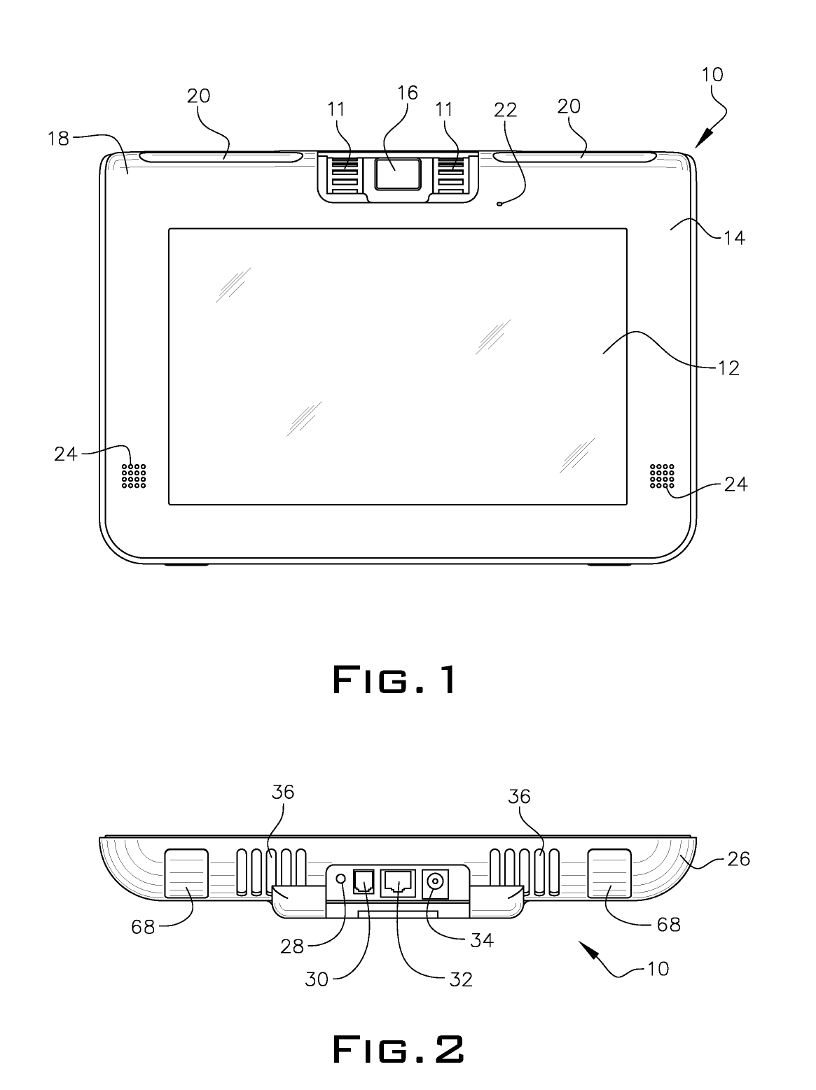

Referring to FIG. 1, an audio video communications device 10 of the present in shown having a monitor 12 on a front side 14, an internal camera 16 mounted on a top portion 18 of front side 14, a pair of lights 20 disposed along top portion 18 on either side of camera 16, a microphone 22 located on device front side 14 and a pair of speakers 24 also located on device front side 14. In the preferred embodiment, monitor 12 is a 10.2″ TFT (thin film transistor) LCD (liquid crystal display) display with a touchscreen user interface; camera 16 is a webcam capable of producing a 30 fps (frames per second), true-to-life video stream; and lights 20 are LEDs. Although in the preferred embodiment a pair of lights 20 (or light sets) is (are) employed, a single light, a single set or a multiplicity of lights can be employed in alternate embodiments. Also, light sources other than LEDs can be employed. Further, the position of lights 20 can be moved to alternate locations on device 10, such as, by way of example along side walls of device 10 or along a bottom peripheral edge. Still further, any of the various communication ports contained in device 10 could be used to employ external lights that achieve the same result of lights 20. Still further, nothing herein limits that the location of camera 16 be positioned where it is shown in the preferred embodiment of FIG. 1. Camera 16, like lights 20, can be located along other areas of front side 14 of device 10 that facilitate a clear angle of the face and upper body, if necessary, such as typically used in sign language communication, of the person using device 10 of the present invention.

Referring now to FIG. 2, a bottom side 26 of device 10 is shown wherein a device reset 28 is employed along with an RJ-11 port 30, an Ethernet connection port 32 and an AC adapter jack 34 for connection to a DC power converter (not shown) for supplying AC power to device 10. Further, although not shown audio video communications device 10 can also be powered by batteries, disposal or rechargeable, in a compartment provided therein. Further to FIG. 2, a pair of air vents 36 is employed along bottom side 26 for permitting excessive heat that may build-up within device 10 to escape there through. Nothing herein limits the rearrangement or exclusion, in any combination thereof, of elements 28, 30, 32 and 34 as shown in FIG. 2.

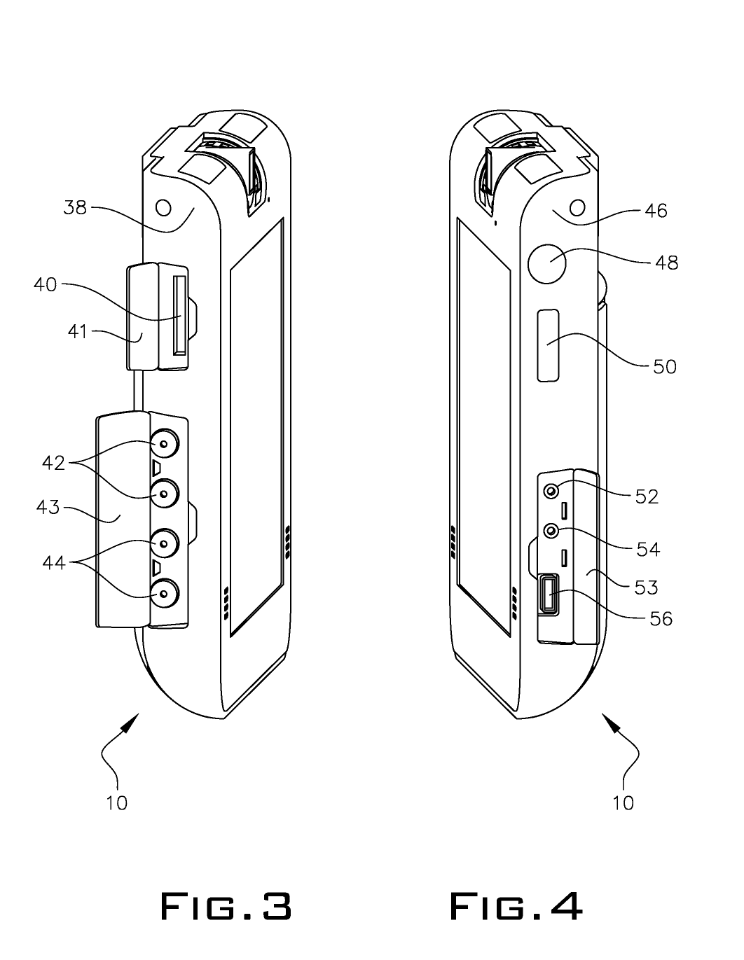

With reference now to FIG. 3, a left side 38 of device 10 is shown wherein an SD (Secure Digital) memory card slot 40 (or other like memory-card slot) is employed along with standard Audio-Video In 42 and Out 44 connections. Both slot 40 and A/V In and Out connections, 42 and 44 respectively, are enclosed by covers 41 and 43, respectively. In the preferred embodiment, A/V In and Out connections, 42 and 44, are stereo connections, but nothing herein limits that in an alternate embodiment of device 10 to employ mono connections. In the preferred embodiment, standard A/V In and Out, 42 and 44 respectively, are RCA jacks, however other connections could be employed such as optical, S-VHS, video component and SPID/IF connections. SD memory slot 40 is configured to receive any number of different flash (non-volatile) memory cards.

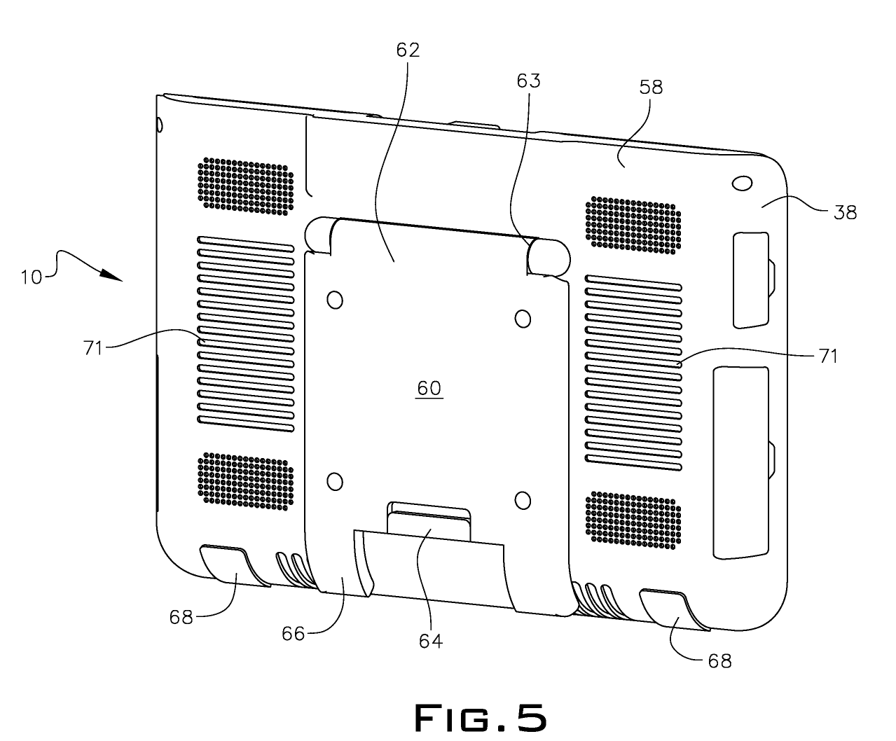

With reference now to FIG. 4, a right side 46 of device 10 is shown having a power switch 48, a volume control 50, a headphone jack 52, a microphone jack 54 and a USB 2.0 port 56. In the preferred embodiment headphone and microphone jacks, 52 and 54 respectively, are mini sized. However, nothing herein limits the use of other sized connectors for jacks 52 and 54. Further, when headphone jack 52 is used by inserting a plug of a headset (not shown), speakers 24 are disengaged. And therefore, volume control 50 operates either the volume level of a set of employed headphones (not shown) or speakers 24 (as shown in FIG. 1), depending on which is being used at any given moment. Although not shown, a volume mute button can also be employed to interrupt volume control 50. Volume control can also be employed by way of a graphic user interface (GUI) on the touch-screen monitor, or both a physical button and a GUI button can be employed. Further, a Firewire connection port (also not shown) can be employed in audio video communications device 10 for communicating with peripherals that employ such type of connector. Also not shown, but which can be employed with device 10, is a wireless transmitter using a protocol such as IEEE 802.11 and its equivalent for providing wireless connectivity to either a LAN (local area network) or a WAN (wide area network). Headphone jack 52, microphone jack 54 and USB 2.0 port 56 can be enclosed by a cover 53. It is understood that the exact location of all jacks, ports and connectors on both left and right sides, 38 and 46 respectively, is not critical to the function of device 10, but instead reflect the preferred embodiment. The interchangeability or relocation of the jacks, connectors and ports is achieved in alternate embodiments of device 10 in a multitude of varying combinations.

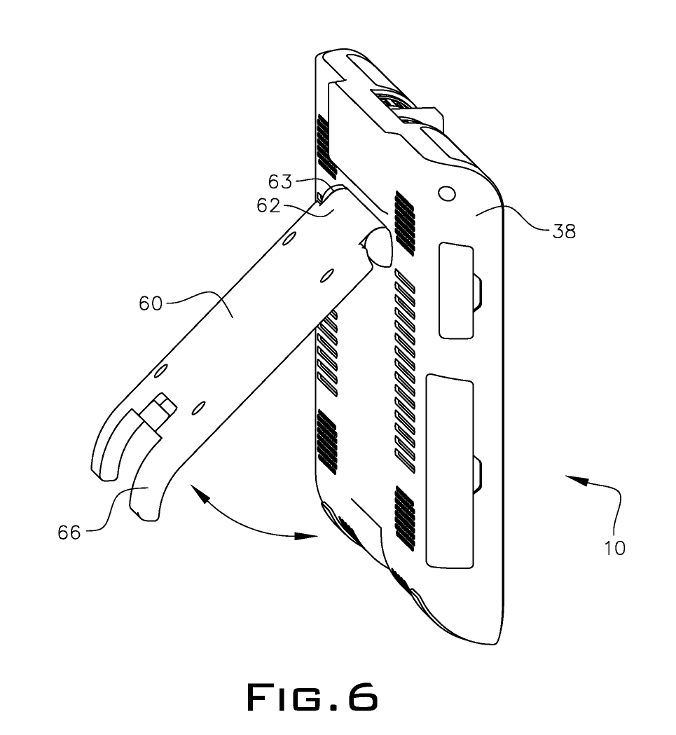

Referring now to FIGS. 5 and 6, a back side 58 of device 10 is shown wherein a retractable kickstand 60 is attached at a top portion 62 of kickstand 69 to device back side 58 by a hinge element 63. Further, a release plate 64 (see FIG. 5) is employed along a bottom portion 66 of kickstand 60 within a notched-out area. As can be appreciated, audio video communications device 10 can be placed on a surface (ideally a flat surface, although not required) and supported thereby by simply pushing upwards on release plate 64, as shown in FIG. 5, and then swinging kickstand 60 outwards, as shown in FIG. 6. As also seen in FIG. 5, a pair of feet members 68 are disposed along device bottom side 26, which assists in supporting device 10 on a surface when kickstand 60 is employed. Feet members 68 are made from a highly frictional material that causes feet members 68 to grip any surface that it comes in contact with for the purpose of affecting minimal or no movement of device 10 when place on a surface, regardless of grade or angle thereof. Further to FIG. 5, a plurality of air vents 71 are disposed along device back side 58 for permitting and encouraging any excess heat within device 10 to escape there through.

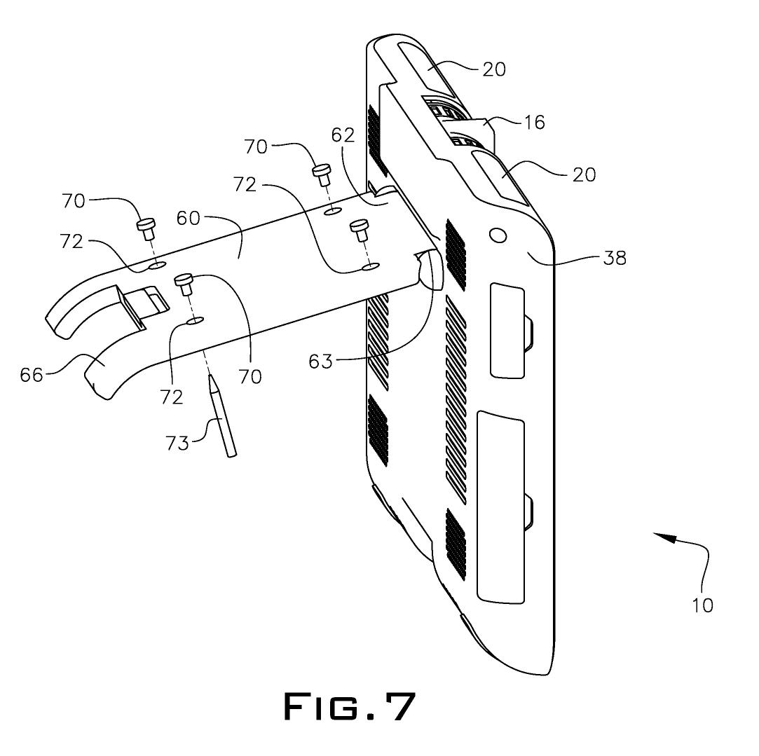

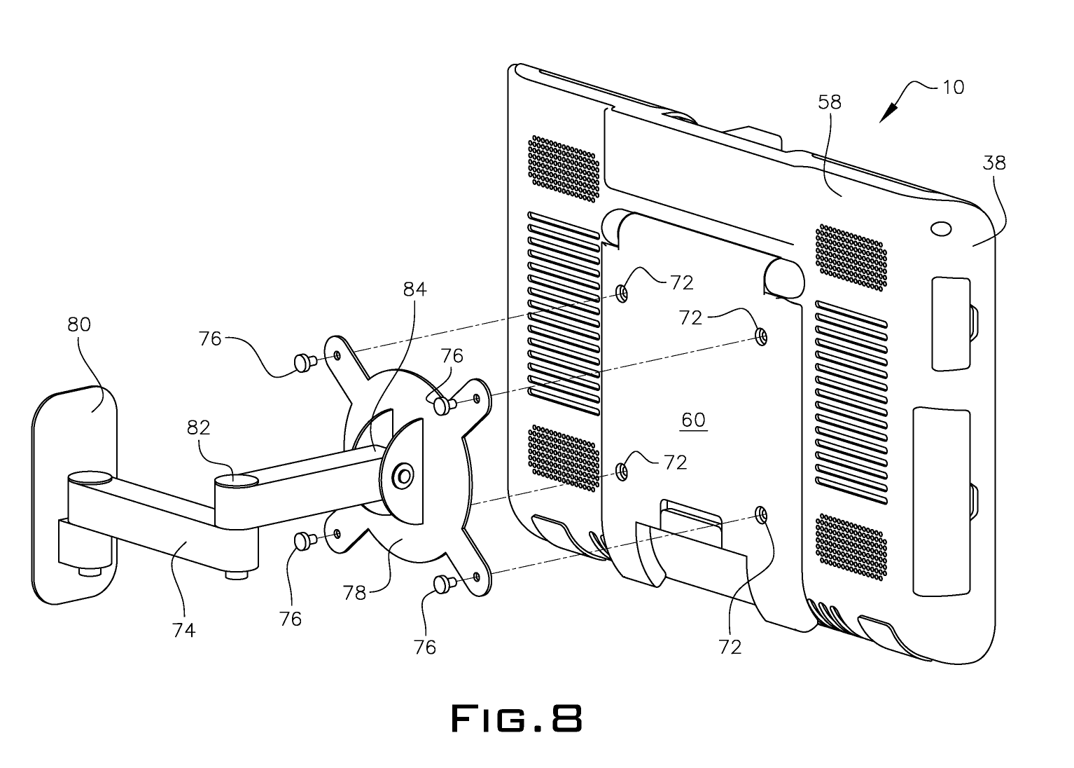

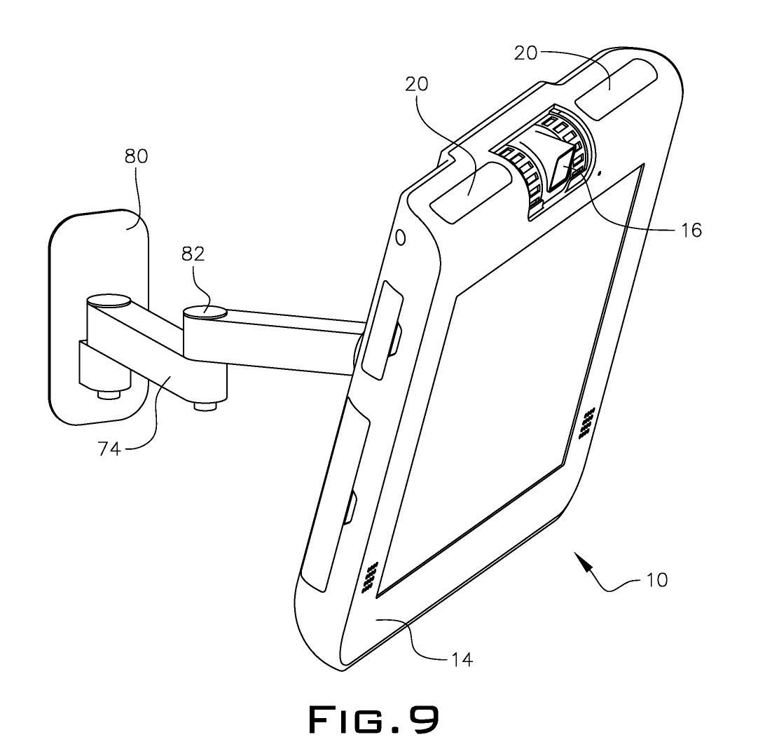

With reference now to FIG. 7, it is shown that a set of rubber stoppers 70 of kickstand 60 can be removed for providing a set of mounting bores 72 for an alternate mounting device (see FIGS. 8 and 9). As illustrated therein, any small pointed object, such as a pencil 73, merely by way of example, can be used to “pop-out” or remove stoppers 70 from mounting bores 72.

Referring first just to FIG. 8, it is shown that an adjustable arm device 74 can be attached to device back side 58 by inserting a set of screws 76 through a mounting plate 78 of arm device 74 and into mounting bores 72 of kickstand 60. As can now be appreciated by viewing both FIGS. 8 and 9, audio video communications device 10 can swivel, move and rotate about several different axis including left and right by the arm 74 at its distal end 80 (attached to a wall, for example), left and right at an elbow joint 82, in a middle portion thereof, and up and down at the mounting plate 78 located at a proximal end 84 of arm device 74 (see FIG. 8).

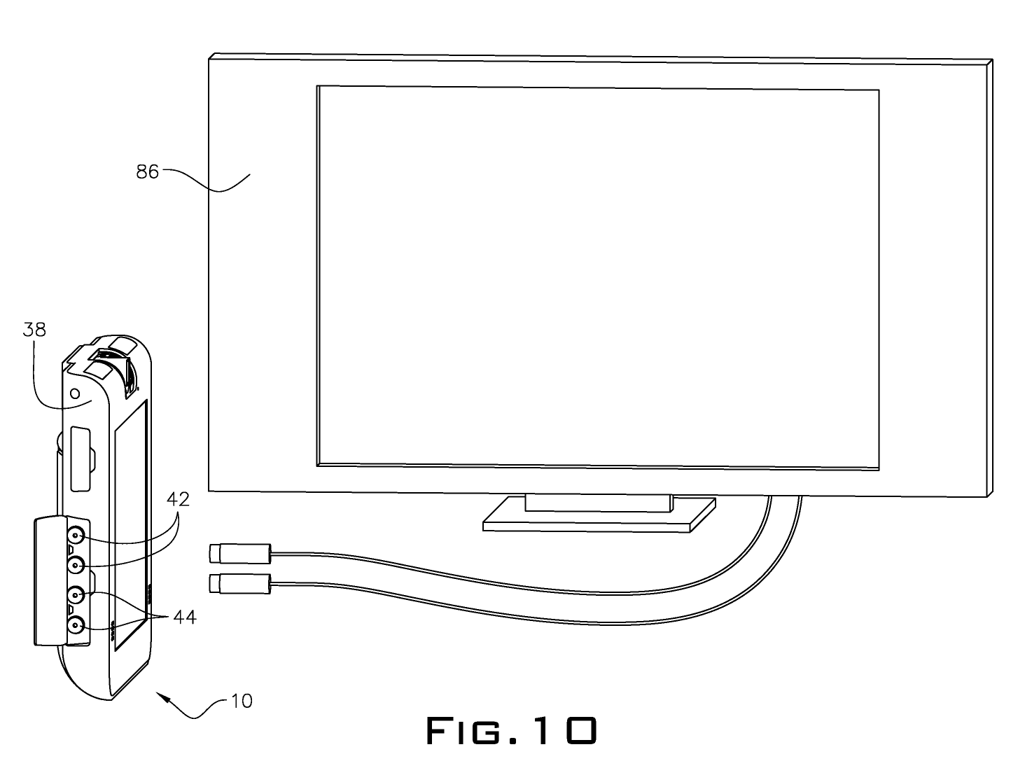

With reference now to FIG. 10, it is shown that audio video communication device 10 can be connected to any standard TV 86 or other external monitor (not shown here) through the use of A/V In and Out connectors, 42 and 44 respectively. Connection in this manner allows for the same video signal being received on device 10 to also be shown on TV 86, or the video signal on device 10 can be defeated and shown only on TV 86, or TV 86 can be used as a second extended monitor as typically used on PCs and laptops by extending the video signal to two screens, or the received video signal of TV 86 can be directed and thereby shown on device 10 monitor 12. In a preferred embodiment, connection of TV 86 to device 10 copies the same video signal received on device 10 thereto. However, through the use of the GUI (graphic user interface), the other two set forth options above can be implemented.

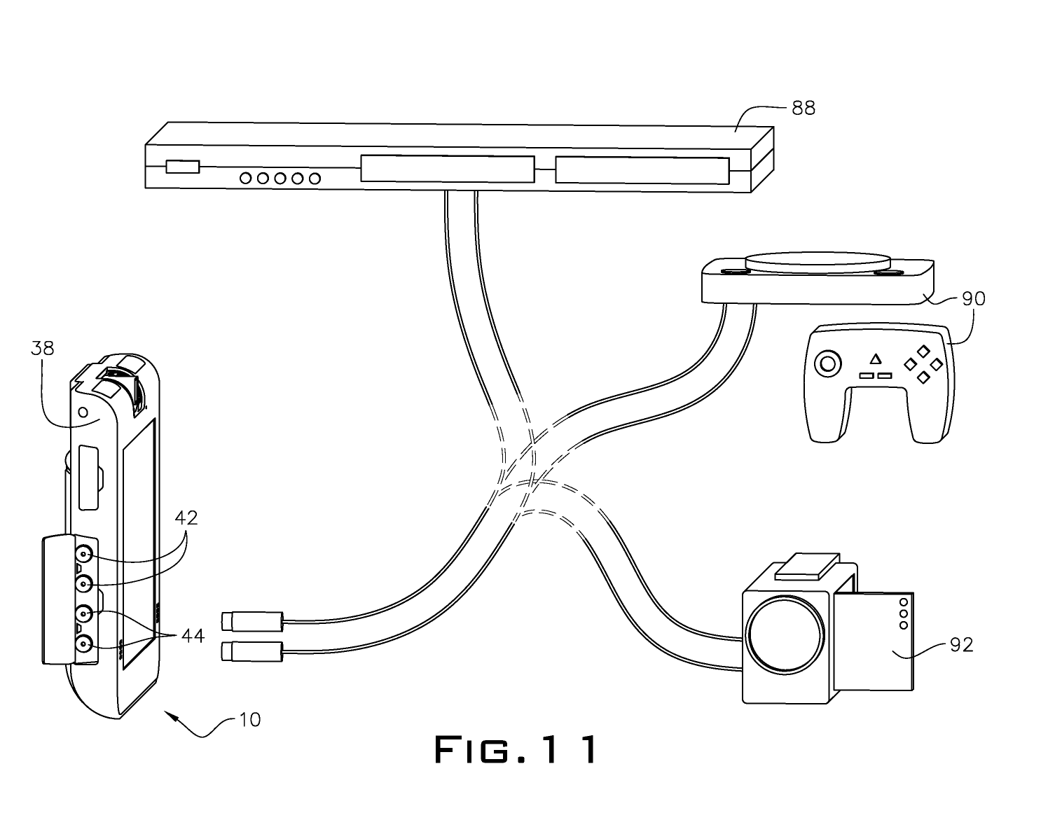

Referring now to FIG. 11, it is shown that other audio and video content providing devices can be connected to audio video communications device 10 by using A/V In and Out connectors 42 and 44 for the displaying and listening to other content on device 10. These include, as shown herein, a DVD player 88, a gaming console 90 and a camcorder 92. These devices are just a few examples and it is understood that any other known type of content providers that utilizes any analog/digital type connector for either audio or video can be connected hereto.

Audio video communications device 10 employs a novel GUI, which is embedded as firmware on a microprocessor (not shown) in device 10. The GUI of device 10 is a real-time operating system that permits device 10 to operate using VoIP (voice over internet protocol) technology. However, nothing herein prohibits device 10 from working over a traditional PSTN. The GUI allows the user of device 10 to create a “user profile” that can be transmitted by the user during a call either when in a point-to-point connection or through a VRS provider connection. This feature allows users of device 10 to have a registered Screen Name and to log into a buddy list and to initiate video and/or audio conversations with simple one-touch (i.e., “one-touch dialing”) functionality.

In a VRS provider call, a server of the VRS provider can manage the transfers using SIP, H.323, RTP protocols between VRS users and translate other technology back and forth from device 10. The user can call a VRS service through device 10 automatically, or by manually entering the phone number or IP address. The server will be able to route the call to the correct designation. When calling a VRS provider, all calls will first be handled by a VRS server then rerouted to the designated address so that the server can be notified of the status of device 10. Once device 10 synchronizes with the server, the server will know where device 10 is actually located, by an IP address. However, each time device 10 receives a new address, the server is updated automatically. It is important to understand that if a user of device 10 is initiating a video connection to a VRS provider, then preferably a server of the VRS provider is responsible for processing the call made by the user from device 10 to the provider, since the VRS server stores profile information of the user. This expedites the call.

Other unique features of the GUI for device 10 are the data repository feature. This allows for video clips with audio files, history of calls, incoming and outgoing history, away message video clip, an address book, a calendar, a buddy list, video/audio mail read/unread, setup preferences, and photo clips to be stored at the server side, while the end user client of device 10 can store video messages, ring/alert patterns, video/audio mail, photo clips, setup configuration and other user preferences as well.

In addition to those features mentioned above, the major features of embedded GUI for device 10 include, but are not limited to, Boot Up, System Setup, Date and Time Setup, IP Setup, Network Speed Setup, Public IP Address Designation, Screen Calibration, Language Designation, Welcome Screen, Home Screen, Login Screen, Main Desktop, VRS and VRI Setup, Make a Call, Buddy List, Call and Use History, Planner, Calendar, Address Book Management, System Reset, Instant Message, Status Bar, Taskbar, Wireless Signal Strength Bar, Video Settings, Audio Settings, Ring Alerts and Patterns, Protocol Settings, System Information, Relay and Power-Up.

Referring now back generally to the audio video communications device 10 of the present invention, it was shown that a USB 2.0 port 56 (see FIG. 4) is employed therewith. This allows for an unlimited ceiling of features and add-ons. By providing optional user upgrades, users will be able to periodically update device 10 to support various hardware devices and thereby maximizing the benefits of device 10. Benefits of using the USB 2.0 port 56 include connection to a keyboard or mouse allowing for convenient and efficient text input. Text input can be used in a variety of ways, such as in standard profile and phone number inputs; text supplementation during a video call; text-to-text communications (such as instant messaging or IP Relay); and in navigating the user interface of device 10. A wireless keyboard or mouse may also be connected to allow the user to move away from device 10 in certain situations without relying on the touchscreen. Another feature available through the use of the USB 2.0 port 56 is its use as a power source for devices relying on a USB power source. This feature may be utilized to power a small light and provide better lighting on a video call for instance, or to charge a digital music player (i.e., an MP3 player) or cell phones with such capabilities. Further, USB port 56 can be used to attach external hard drives, thereby providing a source of memory for the end user of device 10. External memory may be used as a memory source to record content and behavior from using device 10 (such as a DVR or file transfer activities). The external memory could also be used to upload digital content such as streaming video, photos, or file sharing during a video call.

In regards to internal camera 16 (as seen in FIG. 1), it comes equipped with an adjustable mechanism for minimizing the need for external hardware. The user of device 10 may adjust camera 16 for the most optimal sightline by pivoting a roller element 11, which has a finger grip portion formed on either side of camera 16. The high performance camera comes with several features benefiting the user, such as a high-speed frame rate of 30 fps, allowing for superior video quality in high activity video calls. This is very important for end users of device 10 that desire fast action motion, but still place emphasis on clarity (ASL users for example) so that they may better understand fast and/or sloppy finger spelling when using camera 16 of device 10. Further, a high quality video compression is employed, which translates into a video signal that does not suffer from blurry video, ghosting, or freezing, during video calls. And therefore, by placing great reliance on the quality of video, users are more relaxed and appreciative during lengthy calls rather than working hard to decipher video and understand what is being said and thereby generally being frustrated, such as is experienced with the prior art. Other functions for camera 16 can include zoom, focus and face movement tracking.

As stated before in the Summary of the Invention, network connectivity to a packet-type network can be achieved through a SDIO WiFi Card employed in SD slot 40, by use of Ethernet port 32 or through an EVDO wireless connection. However, nothing herein limits the use of an internal wireless transmitter system utilizing an 802.11 or equivalent protocol or Bluetooth or any other known or emerging wireless protocol. Further, connectivity, although not ideal for video transmission, can be achieved through RJ-11 port 30 and a PSTN or an ISDN connection over the PSTN. In the preferred embodiment however, connectivity is realized with a packet-type Network and in particular the Internet. Notwithstanding, other packet-type networks like direct remote access and VPN connections can also be realized with sufficient picture clarity and real-time streaming video.

It is also important to mention that alternate means of alert signals can be employed with device 10 of the present invention. These include, wireless transmitted vibration alerts and the flashing of lights of another party's device 10 remote from the user's device 10. Furthermore, the server of a VRS provider can intercept the alert signal and distribute it elsewhere (IM, e-mail, cell phone or pager vibration and other like means). Also, interruption of other devices other than lights can be accomplished (such as, a TV).

Audio video communications device 10 of the present invention in the preferred embodiment has a plurality of technical specifications. IN the preferred embodiment, these include protocols of SIP (RFC 3261, 3262, 3263, 3264 and 3581). As mentioned before device 10 is H.323 compliant. However, in particular to its Video Codec, device 10 employs H.263/H.264 CODEC. As to its Audio Codec, it employs G.711 a-law and u-law (ITU-T standard for audio “companding”), G.722.1 (an ITU-T standard meant for low bit rate wideband audio coding), G.729A-8 kbps CS-ACELP (an audio data compression algorithm for voice that compresses voice audio in chunks of 10 milliseconds), and G.729b, a 2 byte Silence Insertion Descriptor (SID) frame used for Comfort Noise Generation.

Further, monitor 12 can be displayed at VGA 640×480, QVGA 320×240, CIF 355×288 and QCIF176×144.

The telephony functions include, but are not limited to, Caller ID/Screen Name Display Enable/Disable, Call Waiting Caller ID Enable/Disable, Block/Unblock Caller ID Screen Name, Accept/Forward Priority Call form List, Busy Number Redial, One Click Calling to preferred VRS provider, Call Return (Call the Last Caller), Forward All/On Base/No Answer, Speed Dial List, Blocked Caller List, Anonymous Calls, Do Not Disturb, Call Hold/Waiting/Flash, Hot Line and Warm Line Calling, Hold Timeout, Caller List, Redial List and Direct IP to IP Addressing.

There are additional User Functions that are part of the GUI, which include an Alphanumeric Display and Auto Answer Mode. Further, device 10 and the GUI permit 2-way video conferencing, user input from the touchscreen and soft keyboard, optional USB Keyboard and data transfer to and from USB memory.

Some of the additional call features include Voice Activity Detection (VAD), Comfort Noise Generation (CNG), G.168 Line Echo Cancellation (LEC), Acoustic Echo Cancellation (AEC) and Nonlinear Echo Suppression (AES).

Finally, in a preferred embodiment, device 10 is 11.5″×8″×2″ in size, approximately three lbs. in weight and employs a US120V, 60 HZ AC power source. The output is a 10.2 high resolution display and the input is touchscreen or keyboard or mouse (via USB connector).

It is noted here that many of the unique and novel features of audio video communications device 10 of the present invention facilitate greatly the needs of the hard of hearing or the speech and/or hearing impaired for making hearing capable, spoken word functional equivalent telephone call, by means of video and through the use of sign language. However, nothing herein should be construed to limit the present invention for use only with the hard of hearing or the speech and/or hearing impaired community. In fact, the multitude of features disclosed and described herein, clearly show that audio video communications device 10 has a bevy of other features and uses that also accommodate the hearing capable, spoken word community or a family or group that includes both the hearing impaired and hearing capable. And hence, the reason that the present invention herein is an all-in-one embedded audio video communications device.

Equivalent elements can be substituted for ones set forth herein to achieve the same results in the same way and in the same manner, of which do not take away from the scope of our novel and clearly non-obvious improved audio video communications device.

Having thus described the present invention in the detailed description of the preferred embodiment, what is desired to be obtained in Letters Patent is:

1. An audio video communications device for making a two-way video connection between two parties over a network, the device comprising:
a) a small and generally flat housing enclosing a circuit board;
b) a touchscreen sensitive monitor disposed on a front side of the housing;
c) an internal camera mounted on the front side of the housing;
d) alert means for signaling that a video connection from a remote location is attempting to be made with the device or that a video mail message has been recorded, the alert means mounted on the housing;
e) a graphic user interface embedded in a chipset of the circuit board, the touchscreen monitor interacting with the graphic user interface when a user of the device touches icons displayed on the monitor;
f) a power source; and
g) means for connecting to the network for establishing the two-way video connection.

2. The device of claim 1, wherein the network is a packet-type network.

3. The device of claim 2, wherein the packet-type network is the Internet.

4. The device of claim 1, wherein the two-way video connection is made with a Video Relay Service provider.

5. The device of claim 1, wherein the two-way video connection is made as a point-to-point end user connection.

6. The device of claim 1, further comprising a microphone, and speakers.

7. The device of claim 1, further comprising a SD memory card slot, analog audio and video in and out connections and a USB port.

8. The device of claim 1, wherein the alert means is at least one light element.

9. The device of claim 8, wherein the alert means is a pair of light sources mounted along a top side of the housing.

10. The device of claim 1, wherein the graphic user interface permits a first user of the device to create a unique user profile that allows a second end user of a same or similar compliant device to recognize the first user before a video connection is made between the first and second users.

11. The device of claim 10, wherein the second end user is Video Relay Service provider.

12. The device of claim 1, wherein the power source is chosen from an AC adapter and a battery source.

13. The device of claim 1, wherein the means for connection to the network is chosen from an Ethernet connection, a wireless connection and an RJ-11 connection.

14. The device of claim 1, wherein the internal camera is adjustable.

15. The device of claim 1, wherein a two-way video connection can be made between two parties by engaging a single icon of the graphic user interface on the touch-screen monitor.

16. The device of claim 1, further comprising a retractable kickstand for placing the device on a surface, the retractable kickstand mounting along a back side of the device housing.

17. An audio video communications device for making a two-way audio and/or video connection between two parties over a network, the device comprising:
a) a small and generally flat housing enclosing a circuit board;
b) a touchscreen sensitive monitor disposed on a front side of the housing;
c) an adjustable internal camera mounted on the front side of the housing;
d) a pair of lights mounted on the device top side for signaling that a video connection from a remote location is attempting to be made with the device or that a video mail message has been recorded, the alert means mounted on the housing;
e) a graphic user interface embedded in a chipset of the circuit board, the touchscreen monitor interacting with the graphic user interface when a user of the device touches icons displayed on the monitor;
f) a power source; and
g) means for connecting to the network for establishing the two-way video connection.

18. The device of claim 17, further comprising means for connecting to an alternate signaling device to indicate that an incoming video connection from a remote location is attempting to be made with device.

19. The device of claim 17, wherein the network is a packet-type network.

20. The device of claim 17, further comprising a microphone and at least one speaker.
